(19) United States
(12) Patent Application Publication
(10) Pub. No.: US 2025/0197166 A1
(43) Pub. Date: Jun. 19, 2025

(54) DELIVERY OF LOCATION INFORMATION OF AN ELEVATOR

(71) Applicant: KONE Corporation, Helsinki (FI)

(72) Inventor: Mika LINDQVIST, Helsinki (FI)

(73) Assignee: KONE Corporation, Helsinki (FI)

(21) Appl. No.: 19/066,450

(22) Filed: Feb. 28, 2025

Related U.S. Application Data
(63) Continuation of application No. PCT/EP2022/079217, filed on Oct. 20, 2022.

(51) Int. Cl. B66B 5/00

(52) U.S. Cl. CPC B66B 5/0031

(57) ABSTRACT

According to an aspect, there is provided a solution in which an alarm apparatus may be configured to receive from a management system data representing location information associated with an elevator, and to store the data in a memory accessible by the alarm apparatus, the data to be used in an elevator alarm situation to audibly convey the location information associated with the elevator. According to another aspect, there is provided a solution in which a management system may be configured to receive an identifier associated with an elevator, obtain based on the identifier data representing location information associated with the elevator, and cause transmission of the data representing location information associated with the elevator to the elevator, the location information of the elevator to be used to audibly convey the location information of the elevator in an elevator alarm situation.

### BACKGROUND

During its normal operation, an elevator may become faulty, and a passenger or passengers may be trapped in an elevator car. The elevator car may be equipped with an alarm phone and the passenger is able to call help with the alarm phone. When a call is connected to a service entity, the alarm phone may identify itself by an elevator identifier, or both by the elevator identifier and the location of the elevator, for example, a street address of the building in which the elevator resides in. The elevator identifier is typically known by the elevator, because it may be set in installation time or may be a factory set parameter. Identifying the elevator and the location of the elevator is important for a rescue technician so that help can be provided to a correct elevator.

If the elevator does not provide the service entity with its location, the service entity may be able to obtain the location of the elevator from a location information database based on the elevator identifier. However, it may happen that access to the location information database is not available, and thus the service entity cannot obtain the location information.

There is a need for a solution that would ensure that the location information of the elevator is available to the service entity.

### SUMMARY

According to a first aspect, there is provided a method that comprises receiving, by an alarm apparatus associated with an elevator, from a management system, data representing location information associated with the elevator; and storing, by the alarm apparatus, the data in a memory accessible by the alarm apparatus, the data to be used in an elevator alarm situation to audibly convey the location information associated with the elevator.

In an implementation form of the first aspect, the method further comprises causing transmission of an identifier associated with an elevator to the management system to obtain the location information associated with the elevator.

In an implementation form of the first aspect, the data in the memory comprises the location information associated with the elevator in a file as audio data.

In an implementation form of the first aspect, the data in the memory comprises the location information associated with the elevator in a textual form, and the method further comprises converting the textual form into audio data; and storing the audio data in a file in the memory.

In an implementation form of the first aspect, the method further comprises obtaining an alarm event associated with the elevator; initiating an alarm call to a service entity; obtaining the file comprising the audio data from the memory; and playing back the audio data via the alarm call.

According to a second aspect, there is provided a method that comprises receiving an identifier associated with an elevator; obtaining, based on the identifier, data representing location information associated with an elevator; and transmission the causing of data representing location information associated with the elevator to the elevator, the location information of the elevator to be used to audibly convey the location information of the elevator in an elevator alarm situation.

In an implementation form of the second aspect, the method further comprises obtaining, based on the identifier, the data representing location information associated with the elevator in a textual form from a database; and causing transmission of the data representing location information associated with the elevator to the elevator, the data comprising the location information associated with the elevator in the textual form.

In an implementation form of the second aspect, the method further comprises obtaining, based on the identifier, the data representing location information associated with the elevator in a textual form from a database; converting the textual form into audio data; and causing transmission of the data to the elevator, the data comprising the audio data.

In an implementation form of the second aspect, the method further comprises obtaining, based on the identifier from a database, the data representing location information associated with the elevator, the data comprising the location information associated with the elevator as audio data; and causing transmission of the data to the elevator, the data the audio data.

According to a third aspect, there is provided an apparatus comprising means for receiving, by an alarm apparatus associated with an elevator, from a management system, data representing location information associated with the elevator; and means for storing, by the alarm apparatus, the data in a memory accessible by the alarm apparatus, the data to be used in an elevator alarm situation to audibly convey the location information associated with the elevator.

In an implementation form of the third aspect, the apparatus further comprises means for causing transmission of an identifier associated with an elevator to the management system to obtain the location information associated with the elevator.

In an implementation form of the third aspect, the data in the memory comprises the location information associated with the elevator in a file as audio data.

In an implementation form of the third aspect, the data in the memory comprises the location information associated with the elevator in a textual form, and the apparatus further comprises means for converting the textual form into audio data; and means for storing the audio data in a file in the memory.

In an implementation form of the third aspect, the apparatus further comprises means for obtaining an alarm event associated with the elevator; means for initiating an alarm call to a service entity; means for obtaining the file comprising the audio data from the memory; and means for playing back the audio data via the alarm call.

According to a fourth aspect, there is provided a management system comprising means for receiving an identifier associated with an elevator; means for obtaining, based on the identifier, data representing location information associated with the elevator; and means for causing transmission of the data representing location information associated with the elevator to the elevator, the location information of the elevator to be used to audibly convey the location information of the elevator in an elevator alarm situation.

In an implementation form of the fourth aspect, the management system further comprises means for obtaining, based on the identifier, the data representing location information associated with the elevator in a textual form from a database; and means for causing transmission of the data representing location information associated with the elevator to the elevator, the data comprising 10 the location information associated with the elevator in the textual form.

In an implementation form of the fourth aspect, the management system further comprises means for obtaining, based on the identifier, the data representing location information associated with the elevator in a textual form from a database; means for converting the textual form into audio data; and means for causing transmission of the data to the elevator, the data comprising the audio data.

In an implementation form of the fourth aspect, the management system further comprises means for obtaining, based on the identifier from a database, the data representing location information associated with the elevator, the data comprising the location information associated with the elevator as audio data; and means for causing transmission of the data to the elevator, the data comprising the audio data.

According to a fifth aspect, there is provided a computer program comprising instructions which, when the program is executed by at least one processor, cause the execution of the method of the first aspect.

According to a sixth aspect, there is provided a computer program comprising instructions which, when the program is executed by at least one processor, cause the execution of the method of the second aspect.

According to a seventh aspect, there is provided a computer-readable medium comprising a computer program comprising instructions which, when the program is executed by at least one processor, cause the execution of the method of the first aspect.

According to an eighth aspect, there is provided a computer-readable medium comprising a computer program comprising instructions which, when the program is executed by at least one processor, cause the execution of the method of the second aspect.

According to a ninth aspect, there is provided an alarm apparatus comprising at least one processor and at least one memory storing instructions, that when executed by the at least one processor, cause the apparatus at least to perform: receiving from a management system data representing location information associated with an elevator; and storing the data in a memory accessible by the alarm apparatus, the data to be used in an elevator alarm situation to audibly convey the location information associated with the elevator.

According to a tenth aspect, there is provided an apparatus comprising at least one processor and at least one memory storing instructions, that when executed by the at least one processor, cause the apparatus at least to perform: receiving an identifier associated with an elevator; obtaining, based on the identifier, data representing location information associated with the elevator; and causing transmission of the data representing location information associated with the elevator to the elevator, the location information of the elevator to be used to audibly convey the location information of the elevator in an elevator alarm situation.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow diagram of a method for obtaining location information associated with an elevator according to an example embodiment.

FIG. 2 illustrates a flow diagram of a method for providing location information associated with an elevator according to an example embodiment.

FIG. 3A illustrates an apparatus according to an example embodiment.

FIG. 3B illustrates a management system according to an example embodiment.

FIG. 4A illustrates a management system and an elevator according to an example embodiment.

FIG. 4B illustrates a management system and an elevator according to another example embodiment.

FIG. 5 illustrates a system according to an example embodiment.

### DETAILED DESCRIPTION

Various examples and embodiments discussed herein disclose a solution in which an elevator may automatically obtain location information, for example, an address or coordinate information associated with the elevator, in audio form from a management system using its elevator identifier and store the audio form in its memory for later use.

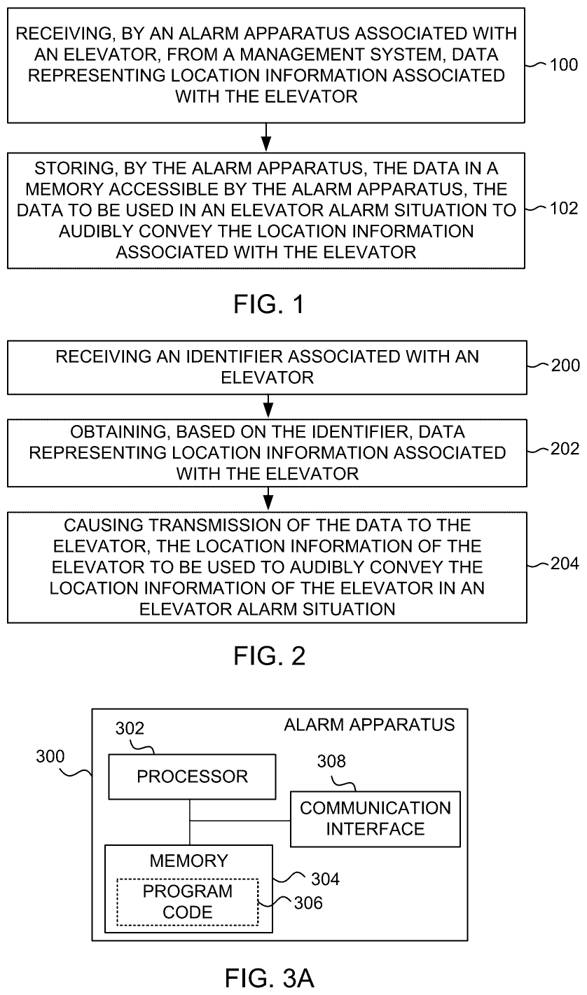

FIG. 1 illustrates a flow diagram of a method for obtaining location information associated with an elevator.

At 100 data representing location information associated with an elevator may be received by an alarm apparatus associated with an elevator from a management system. The data may comprise, for example, an address or coordinate information associated with the elevator, and the data may comprise the location information in a textual form or as audio data. In an example embodiment, before receiving the data, the alarm apparatus may be configured to transmit an identifier associated with the elevator to the management system to obtain the location information associated with the elevator. The management system may store identifiers of elevators and their corresponding location information, and may provide the data based on the stored information.

At 102 the data may be stored by the alarm apparatus in a memory accessible by alarm apparatus, the data to be used in an elevator alarm situation to audibly convey the location information associated with the elevator. The location information may be stored in a textual form, and then at a later point of time, it may be converted to audio data. The location information may be stored in the textual form in a file. In another example embodiment, the file may be named so that the location information is included in the file name. In another example embodiment, the location information may be stored directly as audio data. When an alarm situation occurs, the audio data may be used to deliver the elevator's location information to a service entity.

In an example embodiment, the alarm apparatus may be configured to convert the textual form into audio data, and store the audio data in a file in the memory. In an example embodiment, the conversion may be performed when the data is received from the management system. In another example embodiment, the conversion may be performed only when an alarm event is obtained.

In an example embodiment, the alarm apparatus may be configured to obtain an alarm event associated with the elevator, initiate an alarm call to a service entity, obtain the file comprising the audio data from the memory, and play back the audio data via the alarm call. In an example embodiment, a conversion from the textual form of the location information may be performed after obtaining the alarm event. In another example embodiment, the location information may have earlier been stored in the memory as audio data, and when the alarm event is obtained, the file comprising the audio data is retrieved from the memory.

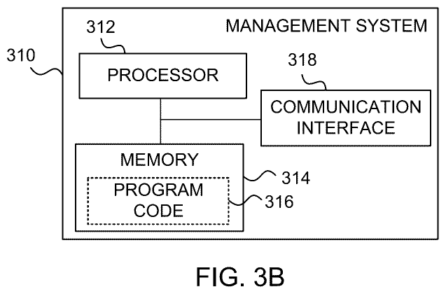

FIG. 2 illustrates a flow diagram of a method for providing location information associated with an elevator according to an example embodiment.

At 200 an identifier associated with an elevator may be received by a management system. The identifier may uniquely identify the elevator among other elevators.

At 202 data representing location information associated with the elevator may be obtained based on the identifier. In an example embodiment, the data representing location information associated with the elevator may be obtained from a database in a textual form. The location information may be, for example, stored in a file, or a file name may comprise the location information. In another example embodiment, the data representing location information associated with the elevator may be obtained from a database in a textual form, and the textual form may be converted into audio data, for example, into a data format comprising audio data that can be played back, for example, .wav, .mp3, .m4a etc.

At 204 transmission of the data representing location information associated with the elevator may be caused to the elevator, the location information of the elevator to be used to audibly convey the location information of the elevator in an elevator alarm situation. The data sent to the elevator may comprise the location information in the textual form or as audio data.

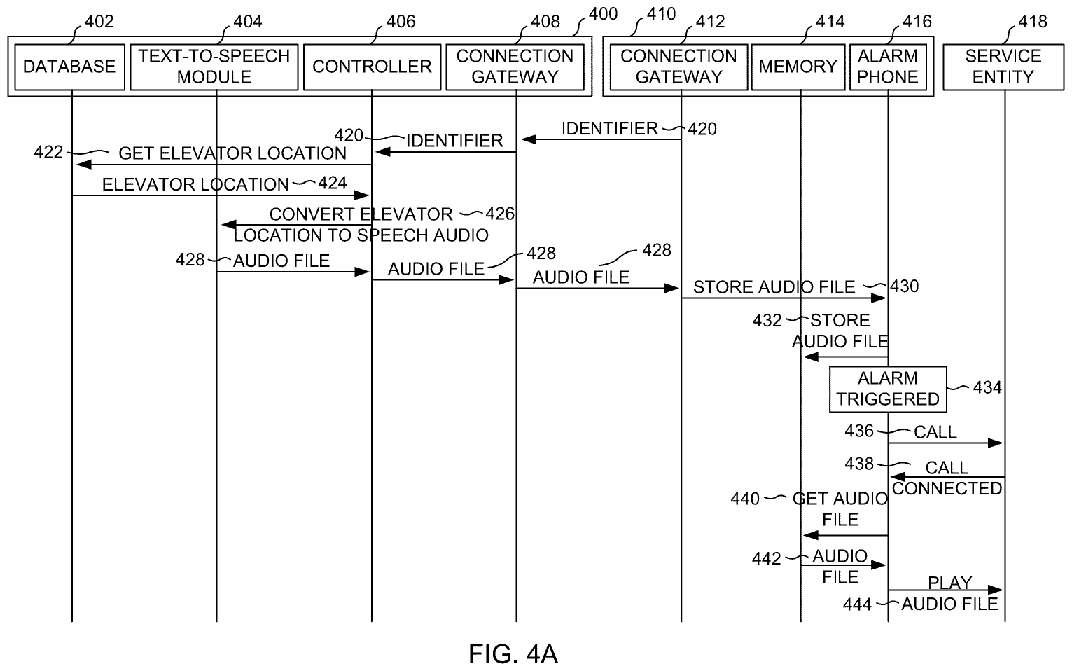

FIG. 3A illustrates an apparatus 300 according to an example embodiment. The apparatus 300 may refer, for example, to an apparatus arranged in an elevator or otherwise associated with the elevator, and it may be configured to implement the method discussed above relating to FIG. 1.

The apparatus 300 may comprise one or more processors 302, and one or more memories 304 that comprise computer program code. The apparatus 300 may also comprise a communication interface 308. The communication interface 308 may provide a wired or a wireless connection to other entities, for example, via the Internet or some other communication network. Although the apparatus 300 is depicted to include only one processor 302, the apparatus 300 may include more than one processor. In an example embodiment, the memory 304 is capable of storing instructions, such as an operating system and/or various applications.

Furthermore, the processor 302 is capable of executing the stored instructions. In an example embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 302 may be configured to execute hard-coded functionality. In an example embodiment, the processor 302 is embodied as an executor of software instructions, wherein the instructions may specifically configure the processor 302 to perform the algorithms and/or operations described herein when the instructions are executed.

The memory 304 may be embodied as one or more volatile memory devices, one or more non-volatile memory devices, and/or a combination of one or more volatile memory devices and non-volatile memory devices. For example, the memory 304 may be embodied as semiconductor memories (such as mask ROM, PROM (programmable ROM), EPROM (erasable PROM), flash ROM, RAM (random access memory), etc.).

In an embodiment, the at least one memory 304 may store program instructions 306 that, when executed by the at least one processor 302, cause the apparatus 300 to perform the functionality of the various embodiments discussed herein. Further, in an embodiment, at least one of the processor 302 and the memory 304 may constitute means for implementing the discussed functionality.

FIG. 3B illustrates a management system 310 according to an example embodiment. The management system 310 may refer, for example, to an apparatus or apparatuses available via a network connection, for example, a cloud server. The management system 310 may be configured to implement the method discussed above relating to FIG. 2.

The management system 310 may comprise one or more processors 312, and one or more memories 314 that comprise computer program code. The management system 310 may also comprise a communication interface 318. The communication interface 318 may provide a wired or a wireless connection to other entities, for example, via the Internet or some other communication network. Although the management system 310 is depicted to include only one processor 312, the management system 310 may include more than one processor. In an example embodiment, the memory 314 is capable of storing instructions, such as an operating system and/or various applications.

Furthermore, the processor 312 is capable of executing the stored instructions. In an example embodiment, the processor 312 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 312 may be configured to execute hard-coded functionality. In an example embodiment, the processor 312 is embodied as an executor of software instructions, wherein the instructions may specifically configure the processor 312 to perform the algorithms and/or operations described herein when the instructions are executed.

The memory 314 may be embodied as one or more volatile memory devices, one or more non-volatile memory devices, and/or a combination of one or more volatile memory devices and non-volatile memory devices. For example, the memory 314 may be embodied as semiconductor memories (such as mask ROM, PROM (programmable ROM), EPROM (erasable PROM), flash ROM, RAM (random access memory), etc.).

In an embodiment, the at least one memory 314 may store program instructions 316 that, when executed by the at least one processor 312, cause the management system 310 to perform the functionality of the various embodiments discussed herein. Further, in an embodiment, at least one the processor 312 and the memory 314 may constitute means for implementing the discussed functionality.

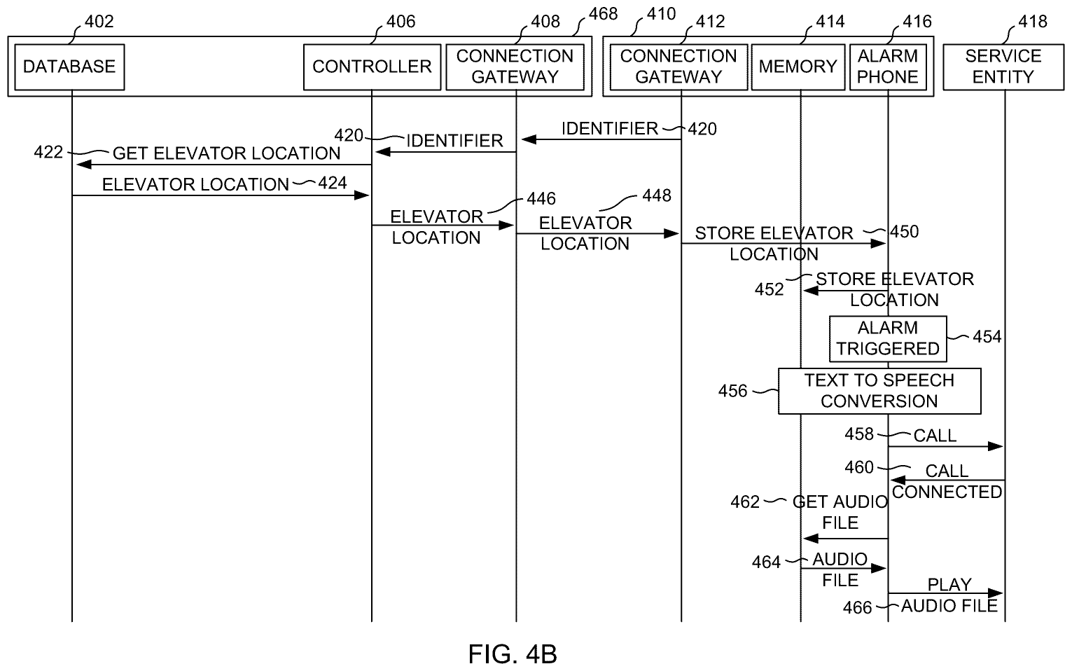

FIG. 4A illustrates a management system 400 and an elevator 410 according to an example embodiment. In the example illustrated in FIG. 4A, the elevator 410 comprises a connection gateway 412 configured to provide connectivity to, for example, the management system 400. The elevator 410 further comprises a memory 414 and an alarm phone 416.

When the elevator 410 connects to the management system 400, for example, for the first time, it may send its elevator identifier 420 to the management system 400 via the connection gateway 412. The elevator identifier 420 may be received by a connection gateway 408 of the management system 400. The elevator identifier 420 may be forwarded to a controller 406. At 422 and 424 the controller 406 may be configured to obtain elevator location information, for example, an elevator address (for example, a street address, geographical coordinates etc.), based on the elevator identifier from a database 402 that stores correspondences between elevator identifiers and their associated elevator location information. The management system 400 may also comprise a text-to-speech module 404 configured to convert the elevator address in a textual form to audio data at 426. The audio data may be stored in an audio file 428 that is transmitted back to the controller 406 and further via the connection gateway 408 to the connection gateway 412 in the elevator 410. The audio file may be transmitted to the alarm phone 416 that stores the audio file in the memory 414 at 432. In another example embodiment, the text-to-speech conversion may have been performed prior to receiving the identifier at 420. In this case, the identifier may be used to retrieve already stored audio data from the database 402, the audio data comprising the elevator location in an audio form.

At some point an alarm may be triggered at 434. When the alarm is triggered there may be one or more passengers in the elevator 410, and the elevator 410 may not be movable any more in an elevator shaft after the alarm. At 436 a call may then be established from the elevator 410 to a service entity 418, for example, a rescue operator, for example, automatically when the alarm is triggered or in response to an action (for example, pressing an alarm button) by a passenger in the elevator 410. After the call is connected at 438, the alarm phone 416 (or some other control unit) may be configured to obtain the audio file from the memory 414 at 440 and 442. When the audio file has been obtained, it can be played back to the service entity 418 at 444. The audio file may be played back to the service entity 418 before an audio connection towards the elevator car 410 is opened. In another example embodiment, the audio file may be obtained when the alarm is triggered and before establishing the call at 436 and 438.

FIG. 4B illustrates a management system 468 and an elevator 410 according to an example embodiment. In the example illustrated in FIG. 4B, the elevator 410 comprises a connection gateway 412 configured to provide connectivity to, for example, the management system 468. The elevator 410 further comprises a memory 414 and an alarm phone 416.

When the elevator 410 connects to the management system 468, for example, for the first time, it may send its elevator identifier 420 to the management system 468 via the connection gateway 412. The elevator identifier 420 may be received by a connection gateway 408 of the management system 468. The elevator identifier 420 may be forwarded to a controller 406. At 422 and 424 the controller 406 may be configured to obtain an elevator location in a textual form, for example, an elevator address (for example, a street address, geographical coordinates etc.), based on the elevator identifier from a database 402 that stores correspondences between elevator identifiers and their associated elevator locations. The elevator location 446, 448 may be transmitted to the alarm phone 416 that stores the elevator location in the memory 414 at 450 and 452.

At some point an alarm may be triggered at 454. When the alarm is triggered there may be one or more passengers in the elevator 410, and the elevator 410 may not be movable any more in an elevator shaft after the alarm. The alarm phone 416 may be configured to perform at 456 a text-to-speech conversion of the elevator information stored in the memory 414 to generate an audio file comprising the elevator location in an audio form. At 458 a call may then be established from the elevator 410 to a service entity 418, for example, a rescue operator, for example, automatically when the alarm is triggered or in response to an action (for example, pressing an alarm button) by a passenger in the elevator 410. After the call is connected at 460, the alarm phone 416 (or some other control unit) may be configured to obtain the audio file from the memory 414 at 462 and 464. When the audio file has been obtained, it can be played back to the service entity 418 at 466. The audio file may be played back to the service entity 418 before an audio connection towards the elevator car 410 is opened.

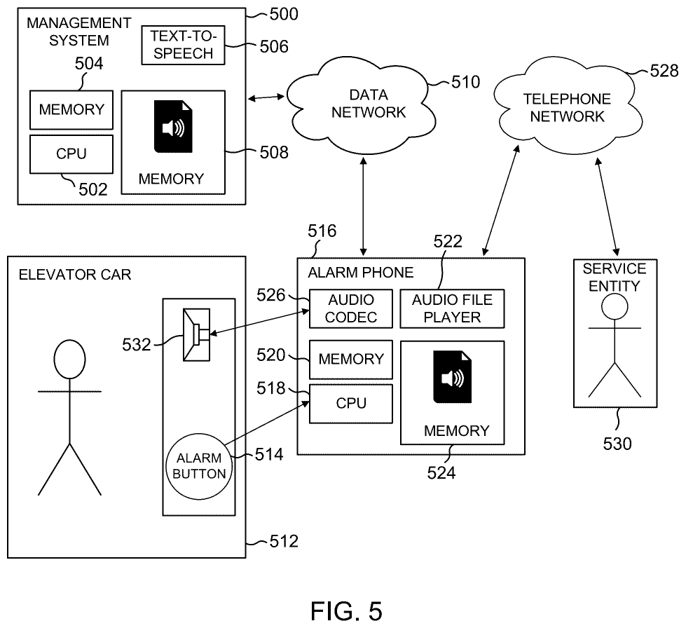

FIG. 5 illustrates a system according to an example embodiment. A management system 500 may be connected via a data network 510 to an alarm phone 516 arranged in an elevator car 510. The management system 500 may comprise a processor 502 connected to a memory 504 comprising program code configured to control operation of the management system 500. A memory 508 may comprise one or more elevator identifiers and elevator location information associated with the one or more elevator identifiers. As illustrated in FIGS. 4A and 4B and in their description, the management system 500 may obtain an elevator identifier and provide an audio file comprising elevator location information associated with the elevator identifier in an audio form to the alarm phone 516. The management system 500 may comprise a text-to-speech converter 506 configured to convert elevator location information in a textual form into audio data stored in an audio file in the memory 508.

The alarm phone 516 may comprise a processor 518 connected to a memory 520 comprising program code configured to control operation of the alarm phone 516. The alarm phone 516 is configured to store the audio file obtained from the management system 500 in a memory 524. When the processor 518 obtains an alarm event triggered, for example, by a passenger in an elevator car 512 via an alarm button 514, the processor 518 may be configured establish a call via a telephone network 528 to a service entity 530, for example, a rescue service. Prior to connecting the call via an audio codec 526 to a speaker 532 in the elevator car 512, the processor 518 may be configured to retrieve the audio file from the memory 524 and play the audio file with an audio file player 522 to the service entity 530 via the established call. Thus, the service entity 530 is provided with the elevator location information, for example, a street address, a building or name identifier, geographical coordinates etc., before the call connection is established via the speaker 532 to the passenger in the elevator car 512.

At least one of the examples and embodiments disclosed above provides a solution that may enable provision of location information of an elevator to a service entity even if an access to a database storing the location information is not available when an alarm associated with the elevator is triggered. Further, at least one of the examples and embodiments disclosed above automates audible location information delivery to the elevator's alarm phone when elevator is connected to the management system. Thus, there is no need for manual configuration of the location information to the elevator at an installation time. Further, at least one of the examples and embodiments disclosed above may ensure that location information of the elevator is more likely to be available for a service entity when an alarm is triggered.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method comprising:
receiving, by an alarm apparatus associated with an elevator from a management system, data representing location information associated with the elevator; and
storing, by the alarm apparatus, the data in a memory accessible by the alarm apparatus, the data to be used in an elevator alarm situation to audibly convey the location information associated with the elevator.

2. The method of claim 1, further comprising:
causing transmission of an identifier associated with an elevator to the management system to obtain the location information associated with the elevator.

3. The method of claim 1, wherein the data in the memory comprises the location information associated with the elevator in a file as audio data.

4. The method of claim 1, wherein the data in the memory comprises the location information associated with the elevator in a textual form, and the method further comprises:
converting the textual form into audio data; and
storing the audio data in a file in the memory.

5. The method of claim 3, further comprising:
obtaining an alarm event associated with the elevator;
initiating an alarm call to a service entity;
obtaining the file comprising the audio data from the memory; and
playing back the audio data via the alarm call.

6. A method comprising:
receiving, by a management system, an identifier associated with an elevator;
obtaining, by the management system based on the identifier, data representing location information associated with the elevator; and
causing, by the management system, transmission of the data representing location information associated with the elevator to the elevator, the location information of the elevator to be used to audibly convey the location information of the elevator in an elevator alarm situation.

7. The method of claim 6, further comprising:
obtaining, based on the identifier, the data representing location information associated with the elevator in a textual form from a database; and
causing transmission of the data representing location information associated with the elevator to the elevator, the data comprising the location information associated with the elevator in the textual form.

8. The method of claim 6, further comprising:
obtaining, based on the identifier, the data representing location information associated with the elevator in a textual form from a database;
converting the textual form into audio data; and
causing transmission of the data representing location information associated with the elevator to the elevator, the data comprising the audio data.

9. The method of claim 6, further comprising:
obtaining, based on the identifier from a database, the data representing location information associated with the elevator, the data comprising the location information associated with the elevator as audio data; and
causing transmission of the data to the elevator, the data comprising the audio data.

10. An apparatus, comprising:
means for receiving from a management system data representing location information associated with an elevator; and
means for storing the data in a memory accessible by the apparatus, the data to be used in an elevator alarm situation to audibly convey the location information associated with the elevator.

11. The apparatus of claim 10, further comprising:
means for causing transmission of an identifier associated with an elevator to the management system to obtain the location information associated with the elevator.

12. The apparatus of claim 10, wherein the data in the memory comprises the location information associated with the elevator in a file as audio data.

13. The apparatus of claim 10, further comprising:
means for converting the textual form into audio data; and
means for storing the audio data in a file in the memory.

14. The apparatus of claim 12, further comprising:
means for obtaining an alarm event associated with the elevator;
means for initiating an alarm call to a service entity;
means for obtaining the file comprising the audio data from the memory; and
means for playing back the audio data via the alarm call.

15. A management system, comprising:
means for receiving an identifier associated with an elevator;
means for obtaining, based on the identifier, data representing location information associated with the elevator; and
means for causing transmission of the data representing location information associated with the elevator to the elevator, the location information of the elevator to be used to audibly convey the location information of the elevator in an elevator alarm situation.

16. The management system of claim 15, further comprising:
means for obtaining, based on the identifier, the data representing location information associated with the elevator in a textual form from a database; and
means for causing transmission of the data representing location information associated with the elevator to the elevator, the data comprising the location information associated with the elevator in the textual form.

17. The management system of claim 15, further comprising:
means for obtaining, based on the identifier, the data representing location information associated with the elevator in a textual form from a database;
means for converting the textual form into audio data; and
means for causing transmission of the data representing location information associated with the elevator to the elevator, the data comprising the audio data.

18. The management system of claim 15, further comprising:
means for obtaining, based on the identifier from a database, the data representing location information associated with the elevator, the data comprising the location information associated with the elevator as audio data; and
means for causing transmission of the data to the elevator, the data comprising the audio data.

19. A non-transitory computer readable medium storing a computer program comprising instructions which, when the program is executed by at least one processor, cause the execution of the method of claim 1.

20. A non-transitory computer readable medium storing a computer program comprising instructions which, when the program is executed by at least one processor, cause the execution of the method of claim 6.

21. A non-transitory computer-readable medium comprising a computer program comprising instructions which, when the program is executed by at least one processor, cause the execution of the method of claim 2.

22. A non-transitory computer-readable medium comprising a computer program comprising instructions which, when the program is executed by at least one processor, cause the execution of the method of claim 7.
